(19) United States
(12) Patent Application Publication
(10) Pub. No.: US 2015/0158287 A1
(43) Pub. Date: Jun. 11, 2015

(54) PRINTING MACHINE, PRINTING APPARATUS, AND PRINTING METHOD

(71) Applicants: Jun Sakamoto, Osaka (JP); Koji Sakamoto, Osaka (JP)

(72) Inventors: Jun Sakamoto, Osaka (JP); Koji Sakamoto, Osaka (JP)

(73) Assignee: Jun SAKAMOTO, Osaka (JP)

(21) Appl. No.: 14/401,689

(22) PCT Filed: May 18, 2012
(86) PCT No.: PCT/JP2012/062788

§ 371 Date: Feb. 4, 2015

(51) Int. Cl. B41F 16/00

(52) U.S. Cl. CPC B41F 16/00

(57) ABSTRACT

A printing machine (100) according to the present invention includes a rotatable pattern roll (12) and a rotatable transfer roll (14) configured to transfer ink (K) transferred from the pattern roll (12) to a to-be-printed object (S). The transfer roll (14) moves while rotating. For example, the transfer roll (14) moves in any period of time before the ink (K) is transferred from the transfer roll (14) to the to-be-printed object (S), after the ink (K) is transferred from the transfer roll (14) to the to-be-printed object (S), and when the ink (K) is in contact with both the transfer roll (14) and the to-be-printed object (S).

### TECHNICAL FIELD

The present invention relates to printing machines, printing apparatuses, and printing methods.

### BACKGROUND ART

Offset printing has been known as one of printing techniques. The offset printing is performed in a manner that ink is transferred from a printing plate to a transfer roll and is then transferred from the transfer roll to a to-be-printed object. Such the offset printing is called also lithography.

Offset printing machines in which not only the transfer roll but also a printing plate is formed in a roll shape are suitably used in mass printing (see Patent Document 1). The printing machine in Patent Document 1 can perform high speed transfer of ink from the pattern roll to the transfer roll.

### PRIOR ART DOCUMENT

### Patent Document

[Patent Document 1] Japanese Patent Application Laid-Open Publication No. 2004-111822

### SUMMARY OF THE INVENTION

### Technical Problems

However, the printing machine of Patent Document 1 cannot perform appropriate printing on a to-be-printed object having a complicated shape. For example, where a to-be-printed object has a printing surface with a protrusion, the transfer roll may collide with the protrusion of the to-be-printed object. Further, where a to-be-printed object has a projection and a recess, printing pressure of the transfer roll to the to-be-printed object may not be constant, thereby disabling appropriate printing.

The present invention has been made in view of the foregoing problems and has its object of providing a printing machine, a printing apparatus, and a printing method that can provide appropriate printing on a to-be-printed object having a complicated shape.

### Solution to Problem

A printing machine according to the present invention includes: a rotatable pattern roll; and a rotatable transfer roll configured to transfer ink transferred from the pattern roll to a to-be-printed object, wherein the transfer roll moves while rotating.

In one embodiment, the transfer roll moves in any time of a time after the ink is transferred from the transfer roll to the to-be-printed object, a time before the ink is transferred from the transfer roll to the to-be-printed object, and a time when the ink is in contact with both the transfer roll and the to-be-printed object.

In one embodiment, the transfer roll transfers the ink to the to-be-printed object by pressing the to-be-printed object against a to-be-pressed surface, and the transfer roll moves in a manner to change a distance from the to-be-pressed surface.

In one embodiment, the pattern roll moves together with the transfer roll.

In one embodiment, the transfer roll moves in a manner to avoid collision of a part other than a lower end part of the transfer roll with the to-be-printed object.

In one embodiment, in the period of time when the ink is in contact with both the transfer roll and the to-be-printed object, the transfer roll moves in a manner to keep printing pressure of the transfer roll applied to the to-be-printed object almost constant.

In one embodiment, the printing machine further includes: a support member configured to support the pattern roll and the transfer roll; a fixing member; and a position changing member configured to change a position of the support member relative to the fixing member.

In one embodiment, the position changing member includes at least one of a ball screw, a cylinder, a cam, and a gear.

A printing apparatus according to the present invention includes: the above printing machine; and a conveyance section configured to relatively convey the to-be-printed object relative to the printing machine.

In one embodiment, the transfer roll moves according to a shape and a conveyance speed of the to-be-printed object conveyed by the conveyance section.

A printing method according to the present invention includes: transferring ink from a rotating pattern roll to a rotating transfer roll; transferring the ink from the rotating transfer roll to a to-be-printed object; and moving the rotating transfer roll.

In one embodiment, the moving the transfer roll is performed in any time of a time after the ink is transferred from the transfer roll to the to-be-printed object, a time before the ink is transferred from the transfer roll to the to-be-printed object, and a time when the ink is in contact with both the transfer roll and the to-be-printed object.

### Advantages of the Invention

According to the present invention, appropriate printing can be performed on a to-be-printed object having a complicated shape.

### BRIEF DESCRIPTION OF THE DRAWINGS

FIG. 1 is a schematic diagram of a printing machine according to an embodiment of the present invention.

FIGS. 2A-2C are schematic diagrams depicting a printing method in an embodiment.

FIGS. 3A-3C are schematic diagrams depicting a printing method in an embodiment.

FIGS. 4A-4C are schematic diagrams depicting a printing method in an embodiment.

FIGS. 5A-5C are schematic diagrams depicting a printing method in an embodiment.

FIG. 6 is a schematic diagram of a printing apparatus according to an embodiment of the present invention.

FIG. 7 is a schematic diagram of a printing apparatus according to an embodiment of the present invention.

FIG. 8 is a schematic side view of a printing machine according to an embodiment of the present invention.

FIG. 9 is a schematic top view of the printing machine according to the embodiment of the present invention.

FIG. 10 is a schematic diagram of a printing machine according to an embodiment of the present invention.

FIG. 11 is a schematic diagram showing a ball screw and its vicinity in the printing machine shown in FIG. 10.

FIG. 12 is a schematic diagram of a printing machine according to an embodiment of the present invention.

FIG. 13 is a schematic diagram of a printing machine according to an embodiment of the present invention.

FIG. 14A is a schematic diagram of a modified example of a position changing member in the printing machine shown in FIG. 13, and FIG. 14B is a cross sectional view taken along the line 14b-14b′ in FIG. 14A.

FIG. 15 is a schematic diagram of a printing machine according to an embodiment of the present invention.

FIG. 16 is a schematic diagram showing a printing apparatus in an embodiment.

FIG. 17 is a schematic diagram showing a printing apparatus in an embodiment.

FIG. 18 is a schematic diagram showing a printing apparatus in an embodiment.

FIG. 19 is a schematic diagram of a printing machine according to an embodiment of the present invention.

### MODE FOR CARRYING OUT THE INVENTION

With reference to the accompanying drawings, embodiments of a printing machine according to the present invention will be described below. It is noted that the present invention is not limited to the following embodiments.

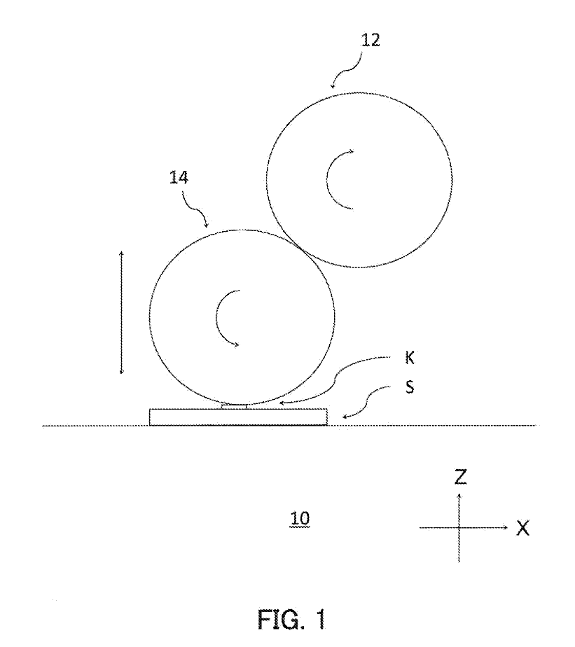

FIG. 1 is a schematic diagram of a printing machine 10 according to an embodiment of the present invention. The printing machine 10 in the present embodiment includes a pattern roll 12 and a transfer roll 14. Both the pattern roll 12 and the transfer roll 14 are rotatable. The diameter of the pattern roll 12 is substantially equal to that of the transfer roll 14 herein.

The surface of the pattern roll 12 is subjected to metal plating. In general, a groove in a predetermined pattern is formed in the pattern roll 12. This pattern corresponds to a line, a figure, a motif, etc. to be printed on a to-be-printed object S. A blanket is provided on the surface of the transfer roll 14. Generally, the blanket is made of rubber. For example, the blanket is made of silicone rubber.

The printing machine 10 performs printing in a state in which both the pattern roll 12 and the transfer roll 14 rotate. Accompanied by rotation of the transfer roll 14, ink K, which has been transferred from the rotating pattern roll 12 to the transfer roll 14, is moved to the lower end part of the transfer roll 14. When the transfer roll 14 comes in contact at its lower end part with the to-be-printed object S, the ink K is transferred from the transfer roll 14 to the to-be-printed object S. Thus, the ink K is printed.

It is noted that the diameter of the pattern roll 12 is substantially equal to that of the transfer roll 14 herein, but the present invention is not limited so. The diameter of the pattern roll 12 may be different from that of the transfer roll 14. However, the diameter of one of the pattern roll 12 and the transfer roll 14 is preferably an integral multiple of the diameter of the other.

The ink K may contain a conductive material. For example, the ink K contains a particulate conductive material and a vehicle. The vehicle contains a resin and a solvent. In addition, the ink K may contain a pigment. Alternatively, the ink K may contain a coating agent. In this case, printing the ink K by the printing machine 10 can result in surface treatment of the to-be-printed object S.

The ink K is supplied to the pattern roll 12 by any method. For example, the ink K may be dripped from above the pattern roll 12. Alternatively, the ink K may be supplied from an ink reservoir (not shown). Or, the ink K may be injected from a nozzle (not shown) toward the pattern roll 12. Further, although not shown herein, it is possible that a scraper is mounted on the pattern roll 12, and a sensor detects the amount of ink accumulated around the interface between the pattern roll 12 and the scraper to control supply of the ink K to the pattern roll 12.

In the printing machine 10 in the present embodiment, the transfer roll 14 moves when it rotates. For example, the transfer roll 14 moves vertically (in a Z direction). Although it will be described later in detail, movement of the transfer roll 14 during its rotation can result in appropriate printing even on a to-be-printed object S having a complicated shape. The transfer roll 14 may move in any time of time before the ink K is transferred from the transfer roll 14 to the to-be-printed object S, time after the ink K is transferred from the transfer roll 14 to the to-be-printed object S, and time when the ink K is in contact with both the transfer roll 14 and the to-be-printed object S.

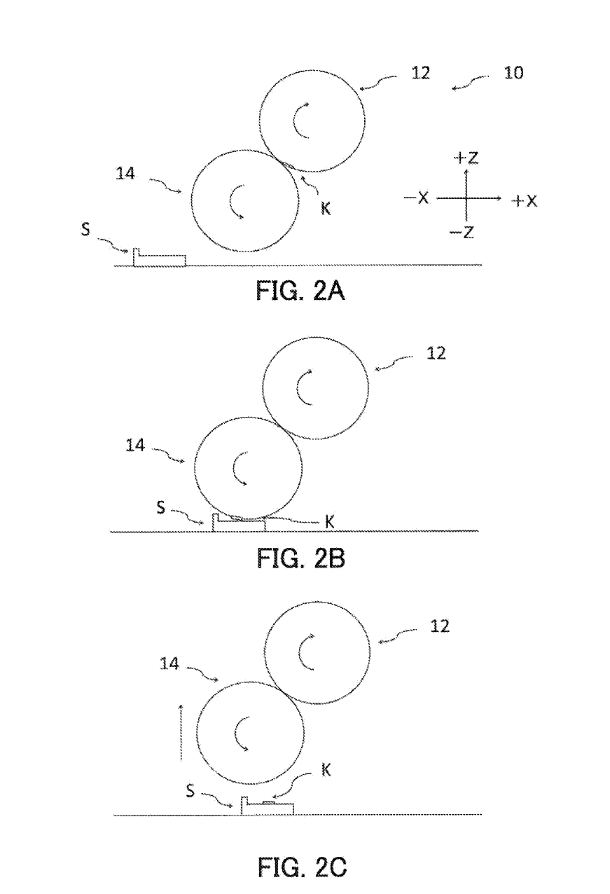

For example, the transfer roll 14 moves before the ink K is transferred from the transfer roll 14 to the to-be-printed object S. A printing method in this embodiment will be described below with reference to FIG. 2.

As shown in FIG. 2A, the ink K is transferred from the rotating pattern roll 12 to the rotating transfer roll 14. The to-be-printed object S is conveyed in the X direction. The position of the printing machine 10 in the X direction is fixed herein. The to-be-printed object S is conveyed in the positive X direction from a negative X direction. Alternatively, the position of the to-be-printed object S in the X direction may be fixed, while the printing machine 10 is conveyed in the negative X direction. Thus, the only needed is relative conveyance of the to-be-printed object S relative to the printing machine 10.

Further, the to-be-printed object S herein includes a flat portion having an almost constant height and a protrusion higher than the flat portion. The protrusion is formed on a side in the negative X direction. The protrusion of the to-be-printed object S comes under the printing machine 10 after the flat portion.

As shown in FIG. 2B, the ink K is transferred from the transfer roll 14 to the to-be-printed object S. To the to-be-printed object S, predetermined pressure is applied from the lower end part of the transfer roll 14 and a to-be-pressed surface that is located below the to-be-printed object S, thereby transferring the ink K to the to-be-printed object S. The ink K is transferred to the flat portion of the to-be-printed object S herein.

Subsequently, as shown in FIG. 2C, the transfer roll 14 moves while rotating. Specifically, the transfer roll 14 moves upward (in the positive Z direction) away from the to-be-pressed surface. Thus, the transfer roll 14 can be prevented from collision with the protrusion of the to-be-printed object S, thereby enabling appropriate printing even on a to-be-printed object having a complicated shape. It is noted that the pattern roll 12 also moves during the movement of the transfer roll 14 herein.

Then, as needed, the transfer roll 14 may be returned to the original printing position. For example, in the case where another to-be-printed object S having the same shape as that shown in FIG. 2A is conveyed next, it is preferable that the transfer roll 14 that has moved upward is returned to the original printing position.

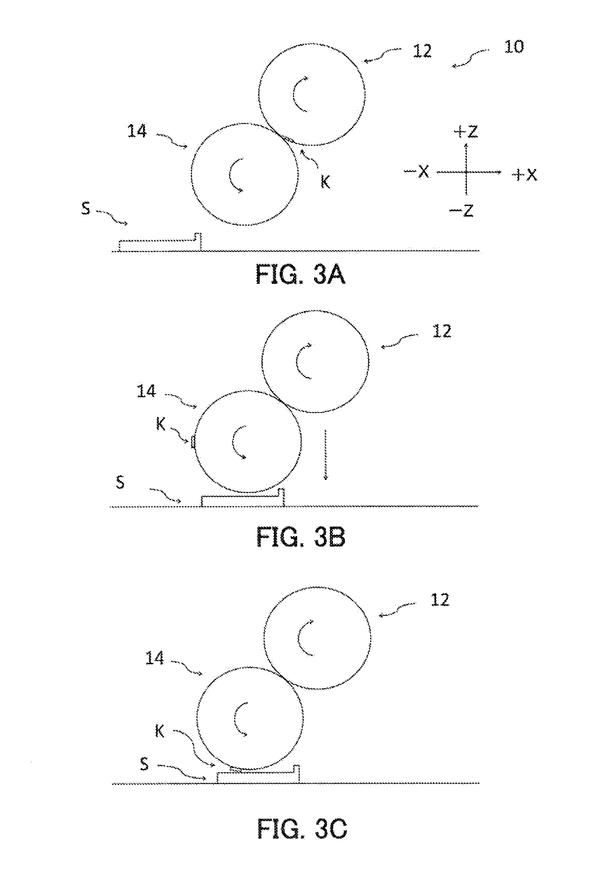

Referring to FIG. 2, the transfer roll 14 moves after the ink K is transferred from the transfer roll 14 to the to-be-printed object S, which however should not be taken to limit the present invention. The transfer roll 14 may move before the ink K is transferred from the transfer roll 14 to the to-be-printed object S. With reference to FIG. 3, a printing method in this embodiment will be described below.

As shown in FIG. 3A, the ink K is transferred from the rotating pattern roll 12 to the rotating transfer roll 14. The to-be-printed object S is conveyed in the X direction. However, as described above, the only needed is relative conveyance of the to-be-printed object S relative to the printing machine 10.

The to-be-printed object S includes a flat portion having an almost constant height and a protrusion higher than the flat portion. The protrusion is formed on a side in the positive X direction herein. The protrusion of the to-be-printed object S comes under the printing machine 10 before the flat portion. The pattern roll 12 and the transfer roll 14 are located at higher levels. At these levels, even when the to-be-printed object S is conveyed as it is, the protrusion of the to-be-printed object S will come in contact with neither the pattern roll 12 nor the transfer roll 14.

As shown in FIG. 3B, the transfer roll 14 moves while rotating. Specifically, after the protrusion of the to-be-printed object S passes under the transfer roll 14, the transfer roll 14 moves in the negative Z direction so that its lower end becomes lower than the protrusion of the to-be-printed object S. The transfer roll 14 may start moving at any time as long as the protrusion of the to-be-printed object S does not collide with the transfer roll 14.

Subsequently, as shown in FIG. 3C, the ink K is transferred from the rotating transfer roll 14 to the to-be-printed object S. To the to-be-printed object S, predetermined pressure is applied from the lower end part of the transfer roll 14 and the to-be-pressed surface that is located blow the to-be-printed object S, thereby transferring the ink K. The ink K is transferred to the flat portion of the to-be-printed object S herein.

Thus, the movement of the transfer roll 14 can prevent the transfer roll 14 from colliding with the protrusion of the to-be-printed object S, thereby achieving appropriate printing even on a to-be-printed object having a complicated shape. It is noted that the transfer roll 14 may be returned to a non-printing position as needed. For example, in the case where another to-be-printed object S having the same shape as that shown in FIG. 3A is conveyed next, it is preferable that the transfer roll 14 that has been moved upward is returned to the non-printing position.

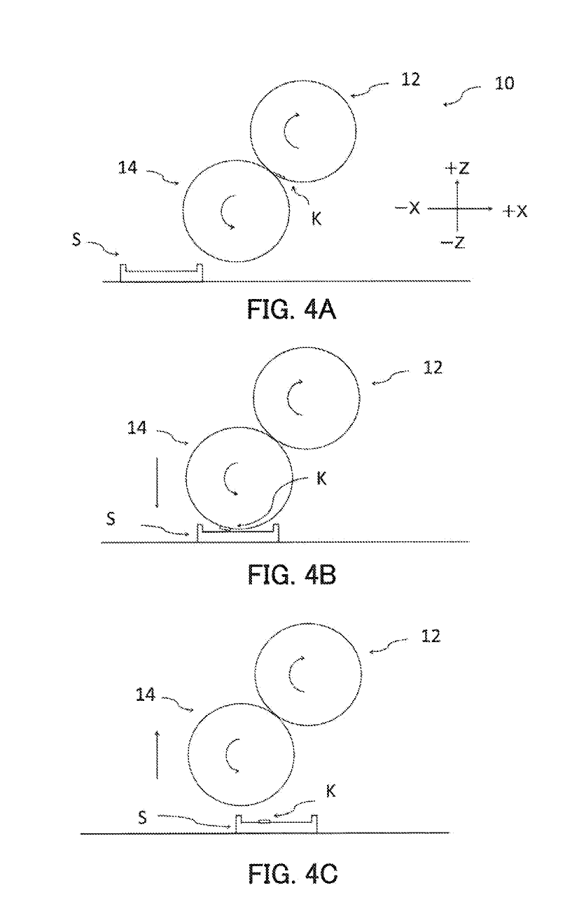

Referring to FIGS. 2 and 3, the transfer roll 14 moves before and after the ink K is transferred from the transfer roll 14 to the to-be-printed object S, respectively, which does not limit the present invention. The transfer roll 14 may move both before and after the ink K is transferred from the transfer roll 14 to the to-be-printed object S. With reference to FIG. 4, a printing method in this embodiment will be described below.

As shown in FIG. 4A, the ink K is transferred from the rotating pattern roll 12 to the rotating transfer roll 14. The to-be-printed object S is conveyed in the positive X direction relative to the printing machine 10. Further, the to-be-printed object S herein includes a flat portion having an almost constant height and protrusions higher than the flat portion. The protrusions are formed on the respective opposite sides in the positive and negative X directions. Thus, the to-be-printed object S has a recessed shape. The protrusion on the side in the positive X direction is referred to as a front protrusion, while the protrusion on the side in the negative X direction is referred to as a rear protrusion in the following description. Before the front protrusion of the to-be-printed object S comes under the transfer roll 14, the pattern roll 12 and the transfer roll 14 are positioned so as not to come in contact with the front protrusion of the to-be-printed object S even when the to-be-printed object S is conveyed as it is.

As shown in FIG. 4B, the transfer roll 14 moves while rotating. Specifically, after the front protrusion of the to-be-printed object S passes under the transfer roll 14, the transfer roll 14 moves in the negative Z direction so that its lower end becomes lower than the front protrusion of the to-be-printed object S, thereby transferring the ink K from the transfer roll 14 to the to-be-printed object S. The transfer roll 14 may start moving at any time as long as the front protrusion of the to-be-printed object S does not collide with the transfer roll 14.

Subsequently, as shown in FIG. 4C, the transfer roll 14 moves while rotating. Specifically, the transfer roll 14 moves upward (in the positive Z direction) away from the to-be-pressed surface. The transfer roll 14 may start moving at any time as long as the rear protrusion of the to-be-printed object S does not collides with the transfer roll 14. This can prevent the transfer roll 14 from colliding with the rear protrusion of the to-be-printed object S. Thus, appropriate printing can be performed even on a to-be-printed object having a complicated shape. The printing machine 10 and the printing methods as above are suitably applicable to printing on a rear window of a vehicle.

For example, a rear window is made of a transparent resin. In view of strength, the rear window may be made of polycarbonate resin, for example. The printing machine 10 can print fine lines made of a transparent conductive material onto the surface of the rear window. For example, the use of the fine lines as a heating wire can remove fog. An example of the transparent conductive material may be indium tin oxide (ITO).

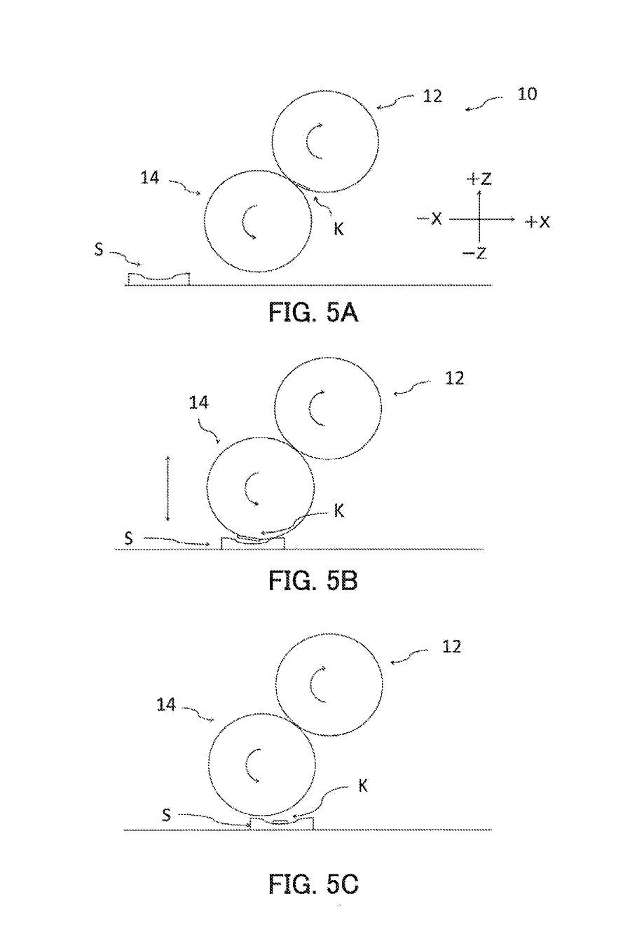

It is noted that the transfer roll 14 moves in the period when the ink K is present on either the transfer roll 14 or the to-be-printed object S in the above description, which however should not be taken to limit the present invention. The transfer roll 14 may move in the period when the ink K is in contact with both the transfer roll 14 and the to-be-printed object S. A printing method in this embodiment will be described next with reference to FIG. 5.

As shown in FIG. 5A, the ink K is transferred from the rotating pattern roll 12 to the rotating transfer roll 14. As described above, the to-be-printed object S is conveyed in the positive X direction relative to the printing machine 10. The to-be-printed object S has a curved printing surface herein.

As shown in FIG. 5B, the ink K is transferred from the rotating transfer roll 14 to the to-be-printed object S. To the to-be-printed object S, predetermined pressure is applied from the lower end part of the transfer roll 14 and the to-be-pressed surface that is located below the to-be-printed object S, thereby transferring the ink K. It is noted that the ink K is transferred to the curved surface of the to-be-printed object S herein. At this time, the transfer roll 14 moves while rotating. The transfer roll 14 moves vertically to follow the curved surface of the to-be-printed object S so as to keep printing pressure of the transfer roll 14 applied to the to-be-printed object S almost constant.

Subsequently, as shown in FIG. 5C, transfer of the ink K to the to-be-printed object S by the transfer roll 14 is finished, and then, the to-be-printed object S is conveyed in the positive X direction. Thus, appropriate printing can be performed even when the to-be-printed object S has such a curved printing surface. Such printing may be also called following printing. It is noted that in order to avoid excessive complication of the drawings, the ink K in FIGS. 1-5 is shown integrally and continuously. However, the ink K may be separated into plural parts so as to form a predetermined pattern.

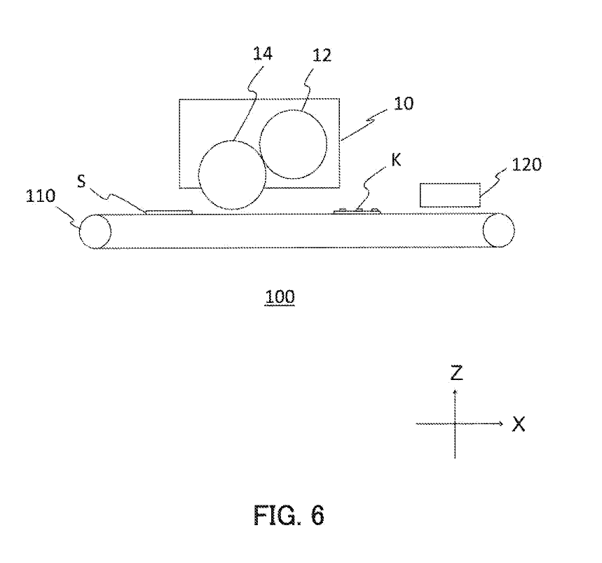

FIG. 6 is a schematic diagram showing a printing apparatus 100 including the printing machine 10. The printing apparatus 100 includes the printing machine 10 and a conveyance section 110 configured to relatively convey the to-be-printed object S relative to the printing machine 10. The conveyance section 110 herein is a conveyor. The conveyor 110 conveys the to-be-printed object S relative to the printing machine 10 that is fixed in the X direction. The printing apparatus 100 may further include a dryer 120 configured to dry the ink K.

In the printing apparatus 100, the moving speed of the transfer roll 14 is set according to the conveyance speed of the to-be-printed object S. For example, when the movable speed of the transfer roll 14 in the Z direction per second is 10 mm/second, it takes 10 seconds for the transfer roll 14 to move in the Z direction by 100 mm. Accordingly, the conveyance speed of the conveyor 110 is set so as not to involve any problems even when the to-be-printed object S is conveyed for 10 seconds.

Further, in FIG. 6, the conveyance section 110 conveys the to-be-printed object S, which however should not be taken to limit the present invention. The conveyance section 110 may convey the printing machine 10.

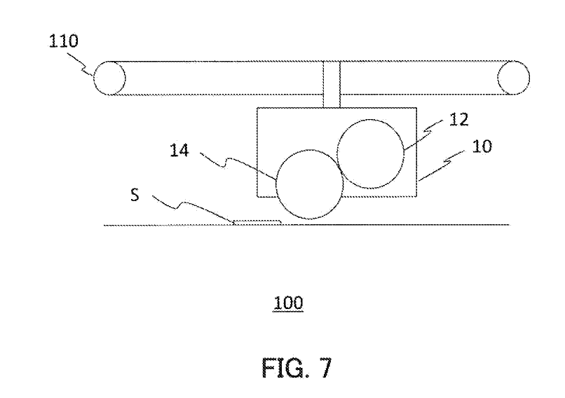

FIG. 7 is a schematic diagram showing a printing apparatus 100 including the printing machine 10. The printing apparatus 100 includes the printing machine 10 and a conveyance section 110 that conveys the printing machine 10. The conveyance section 110 is a conveyor herein. The conveyor 110 conveys the printing machine 10 relative to the to-be-printed object S fixed in the X direction.

It is noted that the conveyance sections 110 in FIGS. 6 and 7 convey either the to-be-printed object S or the printing machine 10, which however should not be taken to limit the present invention. It is possible that the to-be-printed object S and the printing machine 10 are conveyed by different conveyance sections 110 so that the to-be-printed object S is relatively conveyed relative to the printing machine 10.

Furthermore, in the above description with reference to FIGS. 6 and 7, the printing apparatus 100 includes the single printing machine 10, which however should not be taken to limit the present invention. The printing apparatus 100 may include a plurality of printing machines 10 to print ink K having a layered structure on the to-be-printed object S. In addition, in the above description with reference to FIGS. 6 and 7, the printing machine 10 includes the single pattern roll 12, which however should not be taken to limit the present invention. The printing machine 10 may include a plurality of pattern rolls 12 to print ink K having a layered structure to the to-be-printed object S.

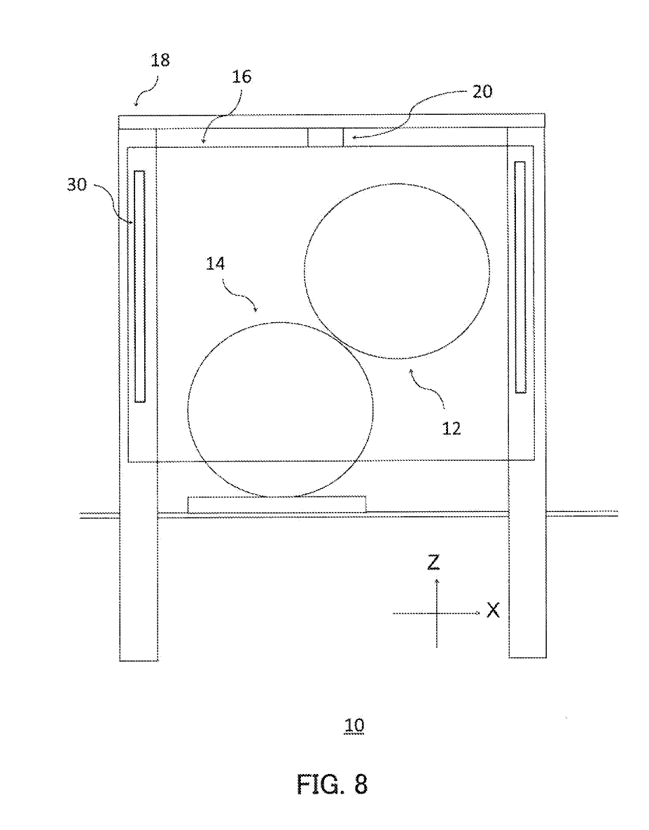

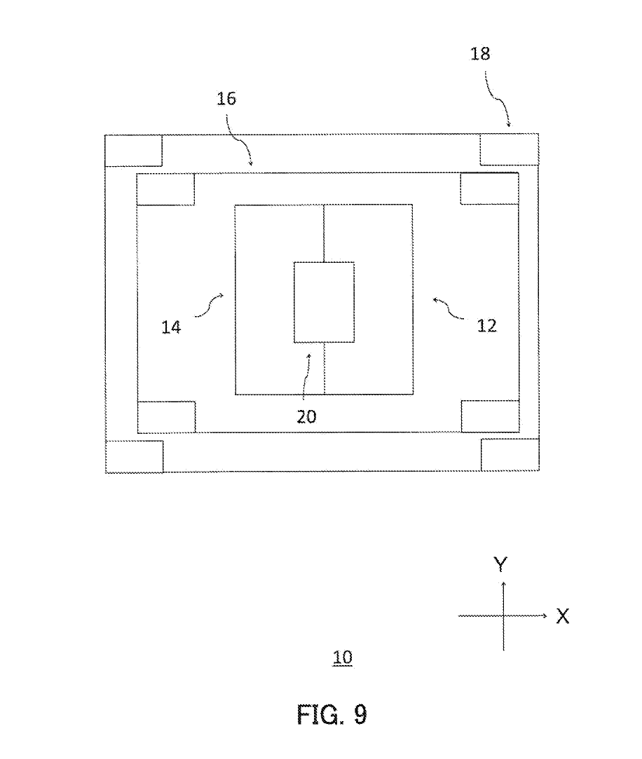

As described above, the pattern roll 12 preferably moves together with the transfer roll 14. A printing machine 10 in this embodiment will be described below with reference to FIGS. 8 and 9.

FIG. 8 is a schematic side view showing the printing machine 10. FIG. 9 is a schematic top view showing the printing machine 10. The printing machine 10 includes, in addition to the pattern roll 12 and the transfer roll 14, a support member 16 that supports the pattern roll 12 and the transfer roll 14, a fixing member 18, and a position changing member 20 that changes the position of the support member 16 relative to the fixing member 18. For example, the position changing member 20 preferably includes at least one of a ball screw, a cylinder (an air cylinder or hydraulic cylinder), a cam (e.g., an eccentric cam), and a gear.

The support member 16 has a top surface and side surfaces and is open at its lower part. The pattern roll 12 and the transfer roll 14 are supported at the top surface and/or the side surfaces of the support member 16. The transfer roll 14 is mounted so that its lower end is lower than the lower end of the support member 16.

The support member 16 is mounted to the fixing member 18 through the position changing member 20. Unless the position changing member 20 varies, the support member 16 is not moved. By contrast, when the position changing member 20 varies, the support member 16 is moved relative to the fixing member 18. For example, varying the position of the support member 16 by the position changing member 20 moves the support member 16 back and forth in the direction perpendicular to the ground (in the Z direction). A direction regulating member 30 may be provided at the fixing member 18 to regulate the direction in which the support member 16 is moved. The direction regulating member 30 may be a linear motion (LM) guide, for example.

In the printing machine 10, the position changing member 20 changes the position of the support member 16 that supports the pattern roll 12 and the transfer roll 14. Accordingly, appropriate printing can be performed on the to-be-printed object S even having a complicated shape. For example, even if the to-be-printed object S has a recessed surface, the transfer roll 14 can be prevented from colliding with a surface of the to-be-printed object S which is not to be printed. Further, the position changing member 20 appropriately moves the support member 16, thereby reducing variation in printing pressure of the transfer roll 14 in printing the ink K on the to-be-printed object S even if the to-be-printed object has a complicated shape.

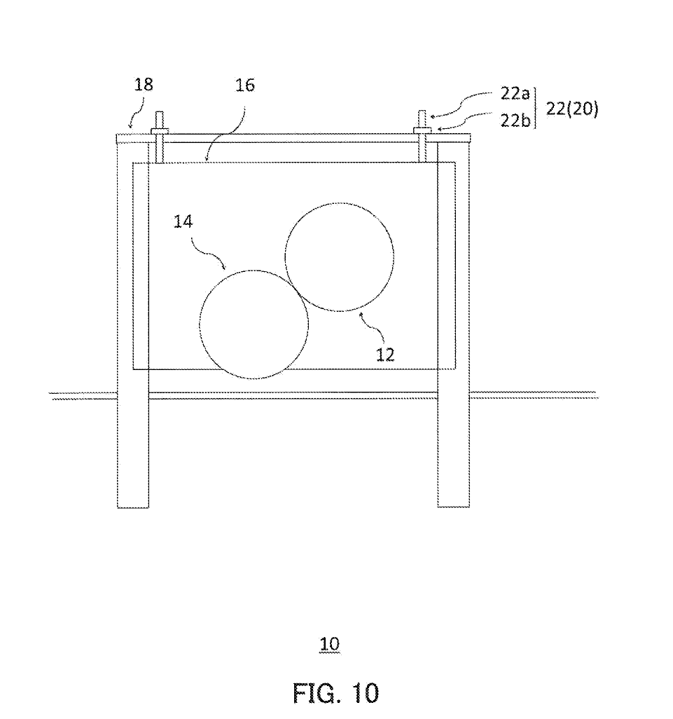

For example, the position changing member 20 has the following configuration. In FIG. 10, each position changing member 20 includes a ball screw 22. The ball screw 22 includes a screw shaft 22a and a nut 22b. Rotation of the nut 22b accompanies movement of the screw shaft 22a. The nut 22b is mounted on the fixing member 18. The tip end of the screw shaft 22a is mounted on the support member 16. The support member 16 is moved together with the nut 22b.

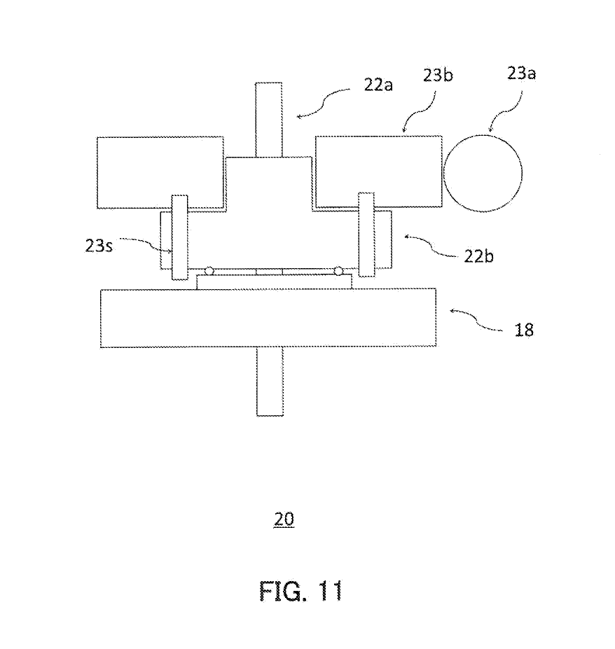

FIG. 11 is a schematic enlarged view of the ball screw 22 shown in FIG. 10 and its vicinity. Here, a worm 23a and a worm wheel 23b are provided above the fixing member 18. The worm wheel 23b is fixed on the nut 22b through a screw 23s. The worm 23a rotates to rotate the nut 22b together with the worm wheel 23b. Accompanied by this rotation, the screw shaft 22a rotates to move the support member 16 fixed on the screw shaft 22a. The worm 23a is driven by a motor (not shown). In the case using a servomotor as the motor, the support member 16 can be moved by a given distance at given timing.

The servomotor is rotatable at 30000 revolutions per minute, for example. Suppose that the motor rotates at 20000 rotations per minute to rotate the worm 23a, the gear ratio between the worm 23a and the worm wheel 23b is 40:1, and the feed pitch of the screw shaft 22a is 5 mm. This can result in 2500-mm movement per minute (about 40-mm movement per second). For example, movement of the transfer roll 14 in the Z direction by 160 mm can be finished in about four seconds. It is noted that, when the feed pitch of the screw shaft 22a is set double, for example, the time required for the movement can be reduced to a half.

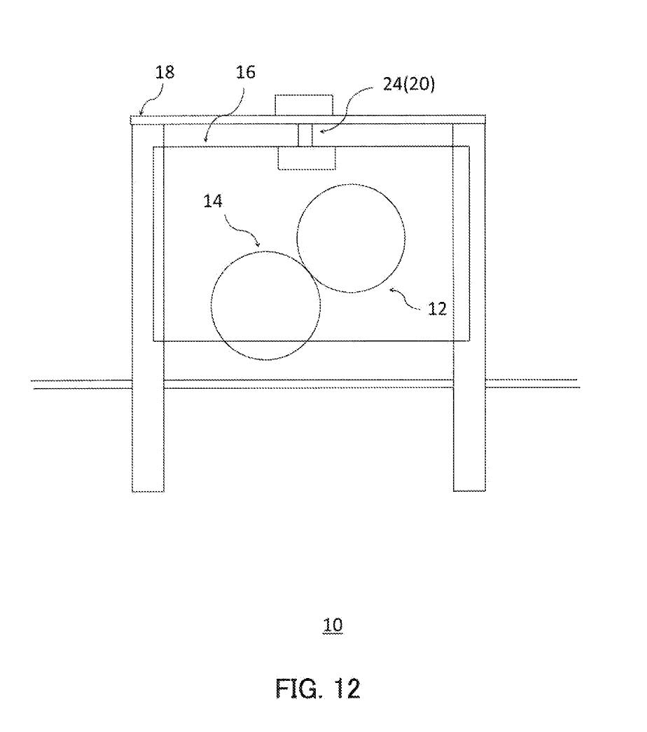

The support member 16 may be moved by a cylinder, for example. Referring to FIG. 12, the position changing member 20 includes a cylinder 24. The cylinder 24 is an air cylinder or a hydraulic cylinder. In order to reduce vibration, the cylinder may include an air cushion. The use of a hydraulic cylinder as the position changing member 20 can result in further speedy movement of the support member 16.

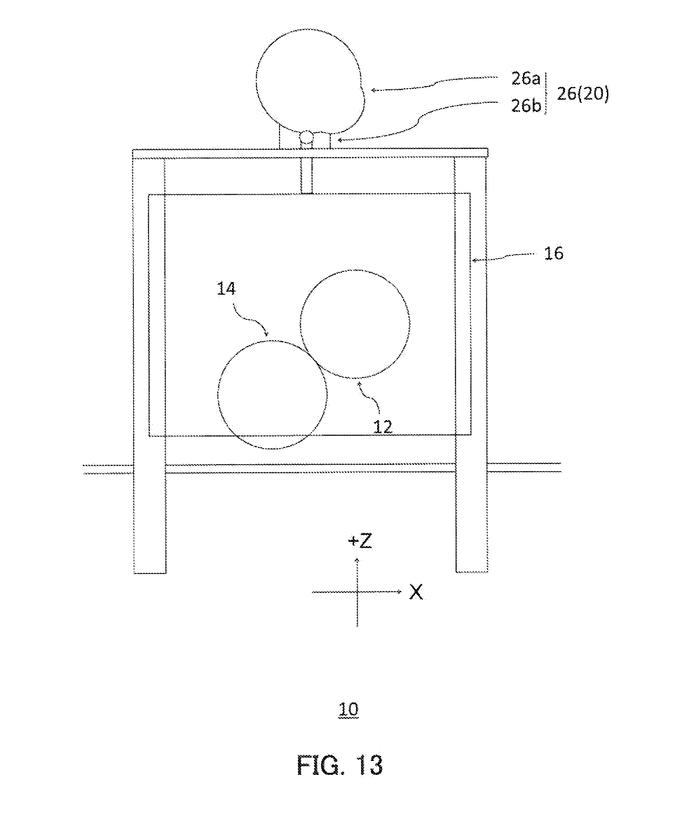

Alternatively, the support member 16 may be moved by a cam (an eccentric cam), for example. Referring to FIG. 13, the position changing member 20 includes a cam 26a and a roller 26b. The support member 16 is fixed on the lower end part of the roller 26b. Bias force in the positive Z direction is applied to the roller 26b. The bias force is applied using a spring, an air cylinder, or the like. The cam 26a rotates to change the position of the roller 26b, thereby changing the position of the support member 16.

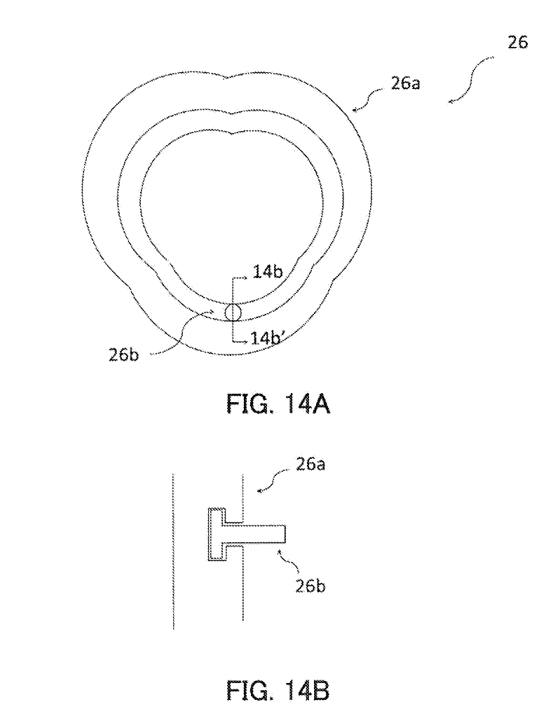

It is noted that the cam 26a and the roller 26b are provided separately in FIG. 13, which however should not be taken to limit the present invention. As shown in FIGS. 14A and 14B, the roller 26b may be capable of passing through a path that the cam 26a forms, and the cam 26a may be formed integrally with the roller 26b.

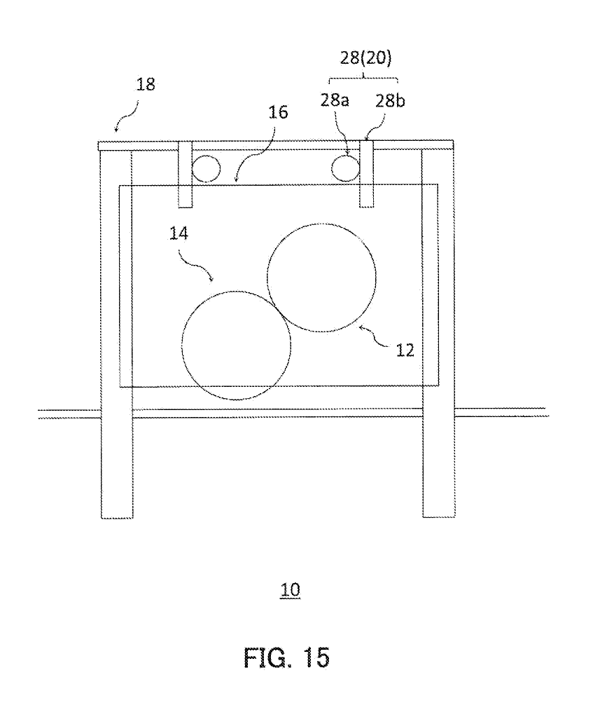

Alternatively, the support member 16 may be moved by a gear, for example. Referring to FIG. 15, each position changing member 20 includes a rack gear 28a and a pinion gear 28b. Rotation of the pinion gear 28b can accompany movement of the rack gear 28a to move the support member 16. It is noted that in following printing, the support member 16 may be moved preferably by a ball screw or a cam.

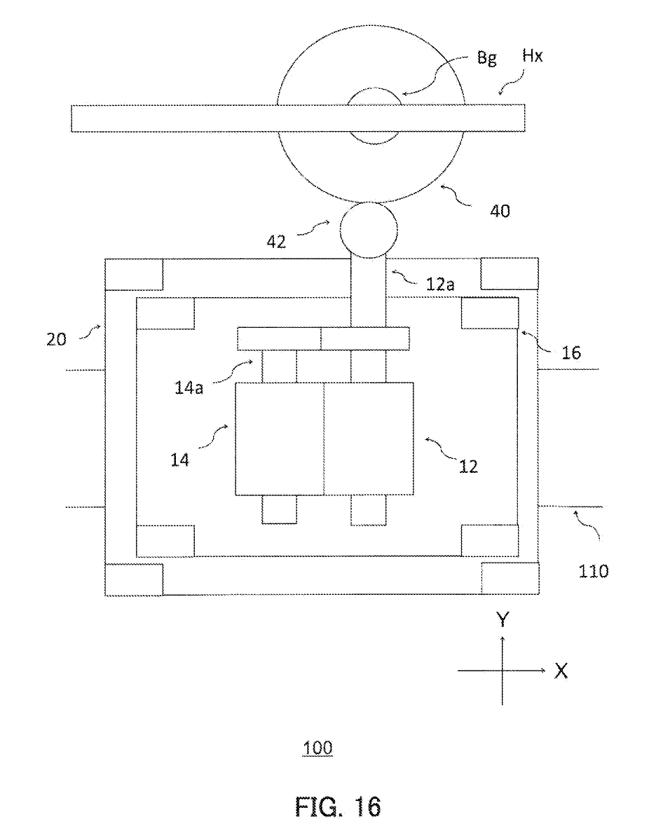

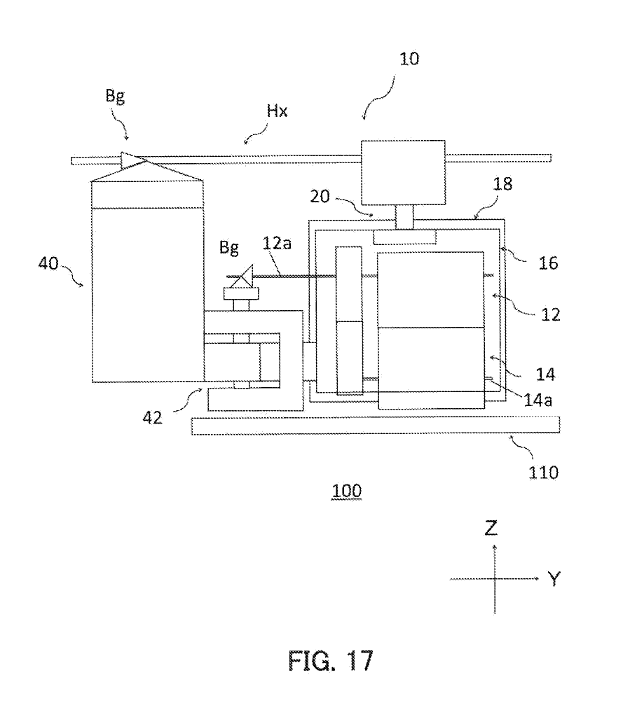

The transfer roll 14 may be held at its opposite ends by shafts (not shown) extending from the respective bottom surfaces (flat surfaces) of its cylindrical form so as to rotate together with the shafts. Alternatively, the transfer roll 14 may be cylindrical in shape so as to rotate in a state in which a core (not shown) with a shaft inside thereof is inserted in the transfer roll 14. Further, the pattern roll 12 may have the same configuration as the transfer roll 14. It is noted that where both the pattern roll 12 and the transfer roll 14 include shafts, the respective shafts are preferably moved together with the pattern roll 12 and the transfer roll 14. With reference to FIGS. 16 and 17, a printing apparatus 100 will be described below.

In the printing apparatus 100, the pattern roll 12 rotates about a shaft 12a as a center of rotation, while the pattern roll 14 rotates about a shaft 14a as a center of rotation. Rotation of the shaft 14a accompanies rotation of the shaft 12a herein. As such, when the pattern roll 12 and the transfer roll 14 are driven by a same power source, the rotational speeds of the pattern roll 12 and the transfer roll 14 can be constant, thereby achieving highly precise driving. It is noted that the shaft 14a rotates accompanied by the rotation of the shaft 12a herein, but the shaft 12a may rotate accompanied by the rotation of the shaft 14a. As such, rotation may be transferred from the shaft of one of the pattern roll 12 and the transfer roll 14 to the shaft of the other roll.

In addition, the printing machine 10 of the printing apparatus 100 further includes spur gears 40, 42. The spur gears 40, 42 rotate about respective axes of rotation in parallel to the Z axis. The spur gear 42 is mounted on the support member 16 and is movable in the Z direction together with the support member 16. The spur gear 40 rotates by converting the rotation of a shaft Hx by a bevel gear Bg. This rotation of the spur gear 40 accompanies each rotation of the spur gear 40, the pattern roll 12, and the transfer roll 14.

The gears are used for joining the members in the aforementioned printing machine 10, but universal joints may be used in place of the gears. However, the use of the gears can achieve highly precise alignment.

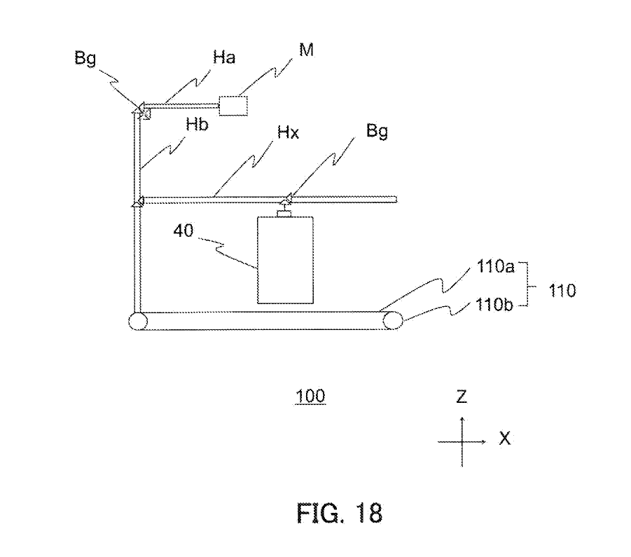

It is noted that the aforementioned shaft Hx may be driven together with the conveyor 110. One example of a printing apparatus 100 will be now described below with reference to FIG. 18. The conveyor 110 includes a toothed belt 110a and sprockets 110b. The toothed belt 110a may be called also a cogged belt.

Here, a shaft Ha is connected to a motor M. The rotation of the motor M is transmitted to the shaft Ha. The shaft Ha is connected to a shaft Hb through a bevel gear Bg, and the shaft Hb is connected to the shaft Hx through a bevel gear Bg. Accordingly, each rotation of the shafts Ha, Hb, Hx is accompanied by the rotation of the motor M. The shaft Hb may be called also an idler shaft, and the shaft Hx may be called also a conveyor shaft. Here, driving the motor M results in printing by the printing machine 10 and conveyance by the conveyor 110.

As described above, the pattern roll 12 and the transfer roll 14 rotate together with the shaft connected to the shaft Hx through the bevel gear Bg. Accordingly, printing and conveyance in the printing apparatus 100 are synchronous with each other. Further, the sprockets of the conveyor 110 rotate together with the shaft Hb.

For example, when the ratio between the diameter of each sprocket and the diameter of the pattern roll 12 is set at an integer, synchronization between conveyance of a substrate and printing can be facilitated. For example, the ratio between the diameter of each sprocket and the diameter of the pattern roll 12 is 2:1. Or, the ratio may be 1:1.

Thus, mechanical synchronization between conveyance and printing can result in facilitation of synchronization between conveyance and printing. It is noted that the conveyance speed of the to-be-printed object S and the printing cycle are adjustable by changing the rotation of the motor M.

The printing apparatus 100 described with reference to FIG. 18 employs mechanical synchronization between printing and conveyance, which however should not be taken to limit the present invention. Printing and conveyance may be synchronized with each other using a servo system.

It is noted that the conveyor 110 conveys the to-be-printed object S at constant speed in the above description, which however should not be taken to limit the present invention. The speed at which the conveyor 110 conveys the to-be-printed object S may vary from time to time. For example, after the conveyor 110 conveys the to-be-printed object S under the printing machine 10, conveyance may be stopped until the printing machine 10 finishes printing on the to-be-printed object S. Then, after the printing machine 10 finishes printing on the to-be-printed object S, the conveyor 110 may restart conveyance. In this way, the conveyor 110 may convey the to-be-printed object S intermittently. However, in order to shorten the time required for printing, it is preferable that the conveyor 110 conveys the to-be-printed object S at constant speed.

Furthermore, as described above, where the printing apparatus 100 employs driving by engagement of the gears, constant conveyance speed of the conveyor 110 can allow the gears to engage with each other at their same parts, thereby enabling conveyance under a constant load. By contrast, where the conveyance speed of the conveyor 110 is changed, or where the conveyance of the conveyor 110 is halted, the loads and the contact surfaces of the gears may not be constant. This may require a comparatively wide margin, thereby disabling highly precise printing. For this reason and in view of the foregoing, it is preferable to set the conveyance speed of the conveyor 110 at constant speed.

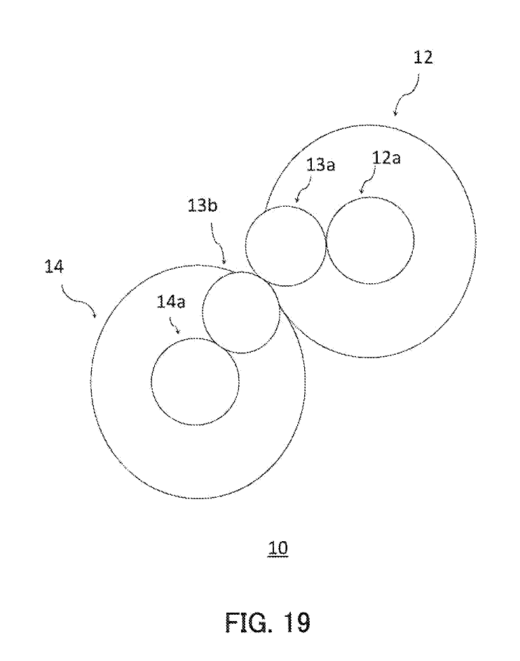

It is noted that the rotation of the shafts 12a, 14a is transmitted directly in the above description, which however should not be taken to limit the present invention. As shown in FIG. 19, the rotations of the shafts 12a, 14a may be transmitted through idler gears 13a, 13b, respectively, for example.

Moreover, the pattern roll 12 moves together with the transfer roll 14 in the above description. This does not limit the present invention. Only the transfer roll 14 may move without allowing the pattern roll 12 to move, thereby separating the transfer roll 14 from the pattern roll 12. The transfer roll 14 moves perpendicularly or obliquely so as to be prevented from collision with the pattern roll 12. For example, where the pattern roll 12 and the transfer roll 14, which are almost equal to each other in diameter, are arranged substantially at almost the same height in transfer of the ink K from the pattern roll 12 to the transfer roll 14, the transfer roll 14 can move in the Z direction at movement with less movement in the X and Y directions. Alternatively, the transfer roll 14 may be moved by a swing arm.

It is noted that where the gears drive the pattern roll 12 and the transfer roll 14, as shown in FIG. 17, separation between the pattern roll 12 and the transfer roll 14 in movement of the transfer roll 14 results in disengagement of the gears. In order to start printing again thereafter, it is then necessary to allow the transfer roll 14 to move to the pattern roll 12 to engage the gears with each other again. At this time, the gears may not appropriately engage with each other. For this reason, it is preferable that the transfer roll 14 moves together with the pattern roll 12.

### INDUSTRIAL APPLICABILITY

According to the present invention, printing can be appropriately performed on a to-be-printed object having a complicated shape.

### EXPLANATION OF REFERENCE CHARACTER

10 printing machine
12 pattern roll
14 transfer roll
16 support member
18 fixing member
20 position changing member
100 printing apparatus

1-12. (canceled)

13. A the printing machine, comprising:
a rotatable pattern roll; and
a rotatable transfer roll configured to transfer ink transferred from the pattern roll to a to-be-printed object,
wherein in relative conveyance of the to-be-printed object relative to the printing machine, the to-be-printed object including a protrusion:
when the to-be-printed object is relatively conveyed relative to the transfer roll in a direction in which the protrusion of the to-be-printed object approaches the transfer roll after the transfer roll transfers the ink to the to-be-printed object, the transfer roll moves away from the to-be-printed object while rotating; or
when the to-be-printed object is relatively conveyed relative to the transfer roll in a direction in which the protrusion of the to-be-printed object moves away from the transfer roll in a position where the to-be-printed object is out of contact with the transfer roll, the transfer roll moves to the to-be-printed object while rotating and transfers the ink to the to-be-printed object.

14. The printing machine of claim 13, wherein
the transfer roll moves in a time when the ink is in contact with both the transfer roll and the to-be-printed object.

15. The printing machine of claim 13, wherein
the transfer roll transfers the ink to the to-be-printed object by pressing the to-be-printed object against a to-be-pressed surface, and
the transfer roll moves in a manner to change a distance from the to-be-pressed surface.

16. The printing machine of claim 13, wherein
the pattern roll moves together with the transfer roll.

17. The printing machine of claim 13, wherein
the transfer roll moves to avoid collision of a part other than a lower end part of the transfer roll with the to-be-printed object.

18. The printing machine of claim 13, wherein
in the period of time when the ink is in contact with both the transfer roll and the to-be-printed object, the transfer roll moves in a manner to keep printing pressure of the transfer roll applied to the to-be-printed object almost constant.

19. The printing machine of claim 13, further comprising:
a support member configured to support the pattern roll and the transfer roll;
a fixing member; and
a position changing member configured to change a position of the support member relative to the fixing member.

20. The printing machine of claim 19, wherein
the position changing member includes at least one of a ball screw, a cylinder, a cam, and a gear.

21. A printing apparatus, comprising:
the printing machine of claim 13; and
a conveyance section configured to relatively convey the to-be-printed object relative to the printing machine.

22. The printing apparatus of claim 21, wherein
the transfer roll moves according to a shape and a conveyance speed of the to-be-printed object conveyed by the conveyance section.

23. A printing method, comprising:
preparing a printing machine including a rotatable pattern roll and a rotatable transfer roll;
preparing a to-be-printed object including a protrusion;
transferring ink from the rotating pattern roll to the rotating transfer roll;
transferring the ink from the rotating transfer roll to the to-be-printed object; and
moving the rotating transfer roll,
wherein in the transferring to the to-be-printed object and in the moving the rotating transfer roll, in which the to-be-printed object is relatively conveyed relative to the printing machine:
when the to-be-printed object is relatively conveyed relative to the transfer roll in a direction in which the protrusion of the to-be-printed object approaches the transfer roll after the transfer roll transfers the ink to the to-be-printed object, the transfer roll moves away from the to-be-printed object while rotating; or
when the to-be-printed object is relatively conveyed relative to the transfer roll in a direction in which the protrusion of the to-be-printed object moves away from the transfer roll in a position where the to-be-printed object is out of contact with the transfer roll, the transfer roll moves to the to-be-printed object while rotating and transfers the ink to the to-be-printed object.

24. The printing method of claim 23, wherein
the moving the transfer roll includes moving the transfer roll in a time when the ink is in contact with both the transfer roll and the to-be-printed object.
